(19) United States
(12) Patent Application Publication
(10) Pub. No.: US 2008/0130304 A1
(43) Pub. Date: Jun. 5, 2008

(54) Underwater light with diffuser

(76) Inventors: Randal Rash, Fort Lauderdale, FL (US); Ian MacDonald, Fort Lauderdale, FL (US)

Correspondence Address: LOTT & FRIEDLAND, P.A., ONE EAST BROWARD BLVD., SUITE 1609, FORT LAUDERDALE, FL, 33301, US

(21) Appl. No.: 11/901,367

(22) Filed: Sep. 17, 2007

Related U.S. Application Data
(60) Provisional application No. 60/844,777, filed on Sep. 15, 2006.

(51) Int. Cl. B60Q 1/00

(52) U.S. Cl. 362/477

(57) ABSTRACT

The present invention is a thru-hull light for installation under the waterline of a vessel comprising a lens capable of diffusing the light broadly through the water. In a preferred embodiment, the lens is a separate, discrete component with a prismatic surface.

This application is related to, cross references and incorporates by reference the subject matter of provisional No. 60/781,678 filed on Mar. 13, 2006 and provisional No. 60/715,625 filed on Sep. 9, 2005.

### BACKGROUND OF INVENTION

Underwater view ports have been used on ships, boats or other watercraft for decorative and safety purposes as well as to aid exploration of the surrounding water. Similarly lighting has been applied to these same watercraft to improve visibility during the dark hours or during periods of overcast or cloudy conditions. Lights have been applied so as to illuminate the sides of the watercraft in order to better visualize the watercraft from a distance, to further enhance the appearance of the watercraft, and to illuminate the surrounding water area. Lights have been mounted in various locations on the deck or hull of the watercraft to accomplish this purpose.

Conventional view ports use a frame to mount a substantially transparent window to the hull. Smaller view ports have used a single piece through hull having a mechanically or chemically fastened window inside the thru-hull fitting.

Thru-hull mounted lights are often in the form of light strips composed of a string of high intensity light bulbs contained within a housing or a plurality of individual lights within a housing applied externally along the perimeter of the hull and oriented to shine downwards along the hull. Various applications of the housings and light shields are used to redirect the light rays from the light source downward along the surface of the hull (including the ability to adjust the housings in order to project beams along a desired path). Although such configurations provide substantial illumination of the hull sides, they are not waterproof or watertight and therefore are placed substantially higher than the waterline. Therefore, little to no illumination of the surrounding water area is provided as the light intensity fades considerably from the light source as it reaches the waterline. Furthermore, because the light rays are directed downward along the surface of the hull, illumination is restricted primarily to the line of the watercraft and therefore does not deviate outward into the surrounding water and may be easily obstructed by other accessories attached to the hull of the watercraft that are closer to the waterline. Also, lights mounted on the exterior of the boat often require replacement and repair from outside the boat rather than from the inside of the boat which usually is fairly cumbersome.

In order to better project the light onto the surface of the water from a light source placed above the waterline, the lights have been extended outward such that they are spaced away from the hull surface. For example, U.S. Pat. No. 5,355,149 discloses a utility light apparatus that is mounted on a gunwale of a boat by applying the light to the distal end of a conventional fishing rod holder such that the light extends out over the side of the boat in an arm-like fashion. Therefore, the extended light pathway illuminates more of the water's surface and is less likely to be obstructed by other appurtenances placed on the side of the boat. However, unless the height of the boat is relatively shallow, the depth to which the light penetrates the water is still very limited by the light intensity as the light source is placed well above the waterline at the gunwale of the boat. Thus, the conventional hull or deck mounted lights do not provide sufficient lighting for visualizing harmful objects within the path of the watercraft or exploring the water around and below the watercraft. Furthermore, lights extending outward from the surface of the boat are easily damaged in comparison to lights which are integrated into the surface area of the boat such that they are only slightly protruding or not protruding at all.

More recently, lights have been integrated into the hull surface area of a watercraft by placing them into the thru-hull fittings of the hull thereby providing a watertight lighting apparatus which may be positioned below the waterline in order to provide a significantly improved visualization of the surrounding water area and to enhance the aesthetics of the boat. Also, by placing the light assembly inside a thru-hull, replacement or repair can be done from the inside of the boat where access is normally much simpler than outside the boat. Typically, a light bulb or lamp supporting means is placed inside the thru-hull from inside the boat and a secured lens is placed between the lamp and the exterior opening of the thru-hull such that the light passes through the lens and into the water. The light bulb supporting means is surrounded by a housing that is either cylindrical for secure fit against the sides of the thru-hull or is a conical, tapered piece which narrows towards the interior of the boat. A flange placed flush against the outside surface of the thru-hull and one or a series of o-rings or watertight sealants or adhesives are used to provide a watertight seal between the lens and the exterior opening of the thru-hull. The exterior flange is usually cast as one piece with a housing which penetrates the hull. The single casting then requires considerable machining to allow for placement of lenses and accessories which make use of the view port. Alternative constructs include manufacture of the housing and flange in two pieces which are then welded together. Welded configurations have the drawback in that if identical materials are not used, welding is difficult and the integrity of the weld may be suspect when used in an underwater environment where failure could be catastrophic.

The flange may be formed with the light housing as one piece or may be separate from the housing such that it is removably attached to the side of the hull by screws that are screwed into holes bored into the hull surface.

Also, it is desirable to form the light housing and flange of two different types of metals in order to obtain the highest heat dissipating light housing on the interior of the hull and the most anti-corrosive flange on the exterior of the hull where the assembly comes into contact with the water. A one-piece configuration limits the entire assembly to one type of metal. Even where the flange and light housing are welded together, there are many metals which cannot be welded tightly to one another. Where the flange must be attached to the hull by screws, several screw-holes must be bored into the hull thereby damaging the hull surface and providing additional inlets where water moisture may create damage. Where the flange is snapped into place, it is difficult to obtain a substantially watertight seal between the flange, lens and the exterior opening of the thru-hull.

All through hull lighting known in the art utilizes lenses made from transparent materials. In fact, U.S. Pat. No. 7,044,623 assigned to Deep Sea Power & Light uses highly transparent flat sapphire glass lenses for the purpose of increasing the efficiency of light transmission. One downside to using such lenses is that the light shines out from the hull in a thin, pencil beam fashion thus necessitating the use of large numbers of lights spaced close together when lighting large areas of the hull is desired. The costs of installation greatly increase due to the need to buy additional lights.

Additionally, where bulb wattages of each lamp commonly range from 35 to 150 watts, installing large numbers of lights on a vessel can overload an inadequately designed electrical system. Where a vessel must carry its electrical source onboard while away from the dock, the need for an ample battery storage or power generating capability for all anticipated uses creates a large practical burden as space is a premium on all vessels, particularly on smaller fiberglass boats. Similarly, there is a practical limit to the weight that can be carried. The smaller the boat, the more it is affected by the weight of a heavy battery. Furthermore, large battery banks require considerable maintenance and can present significant safety concerns if a connection shorts or the batteries are overcharged and vent hydrogen and gaseous sulfuric acid.

The presence of an adequately sized generator can reduce or eliminate the need for storage batteries. However, generators have their own drawbacks. Fuel, a commodity which is becoming increasingly more expensive and scarce in remote areas, is needed in order to operate a generator. Also, generators have inherent safety risks and require maintenance for their safe and efficient operation.

Where underwater lights must be of high intensity in order to be useful, the use of a large number of lights produces a significant amount of heat and dispersing that heat becomes an increasingly difficult problem. High intensity lights installed adjacent to the cabin of the boat will heat the air in the cabin. When in an air-conditioned space, this increases the cooling load and requires additional electrical power to remove the heat. When in a non-climate controlled space, the heat can make an enclosed space uncomfortably warm for the occupants.

It is an object of this invention to reduce the number of lights required for illuminating the area immediately around the hull of a vessel.

It is an object of this invention to reduce the amount of energy required to light the area around the hull of a vessel thereby conserving natural resources.

It is an object of this invention to reduce the amount of heat released by high intensity underwater lights into the interior of a vessel.

It is an object of this invention to provide a thru-hull light in which the light housing contains a means for diffusing the light around the sides of the vessel, thereby reducing the number of lights required for illumination.

### DESCRIPTION OF THE DRAWINGS

FIG. 1 is a cross sectional view of a view port housing a light and containing a diffuser.

FIG. 2a is a front view of a prismatic lens.

FIG. 2b is a side view of a prismatic lens.

FIG. 2c is an oblique view of a prismatic lens.

FIG. 3a is a side view of a retaining ring as means for securing a prismatic layer to the main body of the housing in order to diffuse the light originating from the light source.

FIG. 3b is an oblique view of a retaining ring as means for securing a prismatic layer to the main body of the housing in order to diffuse the light originating from the light source.

### DETAILED DESCRIPTION OF THE INVENTION

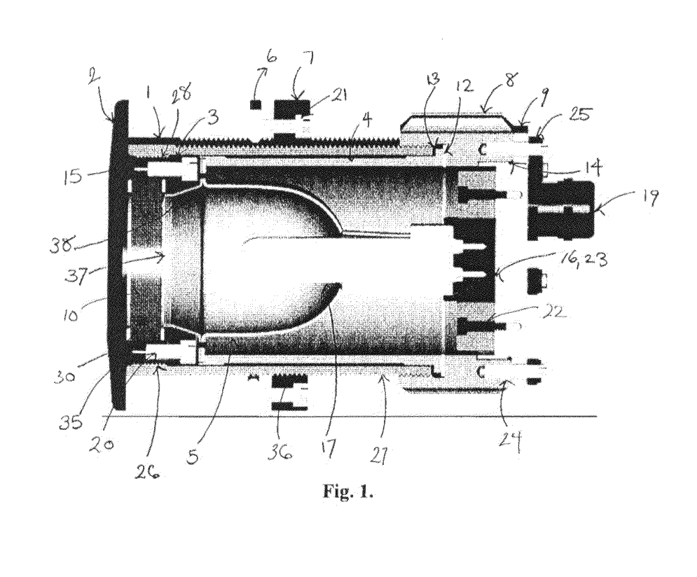

The present invention is a thru-hull view port assembly that can serve as an underwater light and is constructed to have a watertight fit in the hull or deck of a vessel. Referring to FIG. 1, a flange 2 having an inner and outer face is used to mount the assembly to the exterior of the vessel. A substantially transparent lens 10 having a top and a bottom surface is removably mounted on the inner surface of the flange 2.

Lens 10 is in the shape of a disc with ground edges and is preferably composed of heat and pressure resistant borosilicate glass. As will be appreciated by one of skill in the art, any substantially transparent material that is resistant to high temperature and high pressure and is resistant to erosion and chemicals can be used. Suitable materials include chemically hardened or tempered and impact resistant materials such as quartz glass, tempered (Pyrex), borosilicate, or sapphire crystal may also be used. The glass disc is retained in place by glass retaining ring 3 and front flange 2 which is connected to the circumference of the glass retaining ring via cap screws 20. The interior surface of ring 3 is tapered such that the proximal end is of narrower diameter than the distal end. The hollow interior of the mushroom-head shaped portion of the front flange is tapered inward such that the proximal end is of wider diameter than the distal end and the distal end is of narrower diameter than the threaded portion of the front flange. The diameter of the distal end of the mushroom-head shaped portion of the front flange is equal to the diameter of the proximal end of the glass retaining ring thereby forming a retaining groove for capturing the glass disc between the mushroom-head shaped portion of the front flange and the glass retaining ring. Glass gaskets 11 are placed on both sides of the glass disc for watertight seal between the disc and the front flange and the disc and glass retaining ring. Gaskets 11 are preferably 1/16″ thick and composed of compressed Aramid/Buna-N sheet gasket material. The inner surface of flange 2 contains a plurality of threaded screw holes 35 to which a glass retaining ring 3 having a circumferential body defining a lens opening 30 is affixed using bolts 20 threaded into screw holes 35. Glass gaskets 11 are used on either side of the lens to provide a watertight seal. Main body 1 of the assembly is a hollow cylinder with a proximal end having internal threads 26 and a distal end having external threads 27 which is attached to the external threads 28 of the flange 2 by means of the internal threads 26. A polymer o-ring 15 or other suitable sealing means such as silicone, polyether, polyurethane or other sealants acceptable for use below the waterline are used for forming a watertight seal between the flange 2 and main body 1.

The single lens 10 may be shaped to diffuse the light from light source 17 or a separate, diffusing lens 37 may be placed on either side of lens 10 in order to scatter the light emitting from light source 17 into the surrounding water. Thus, the separate lens 37 may be placed between lens 10 and light source 17 within the interior of the housing and/or may be placed on the other side of lens 10 facing the external opening of the hull. In a preferred embodiment, a separate lens 37 is placed on the interior side of lens 10 such that it is adjacent to light source 17.

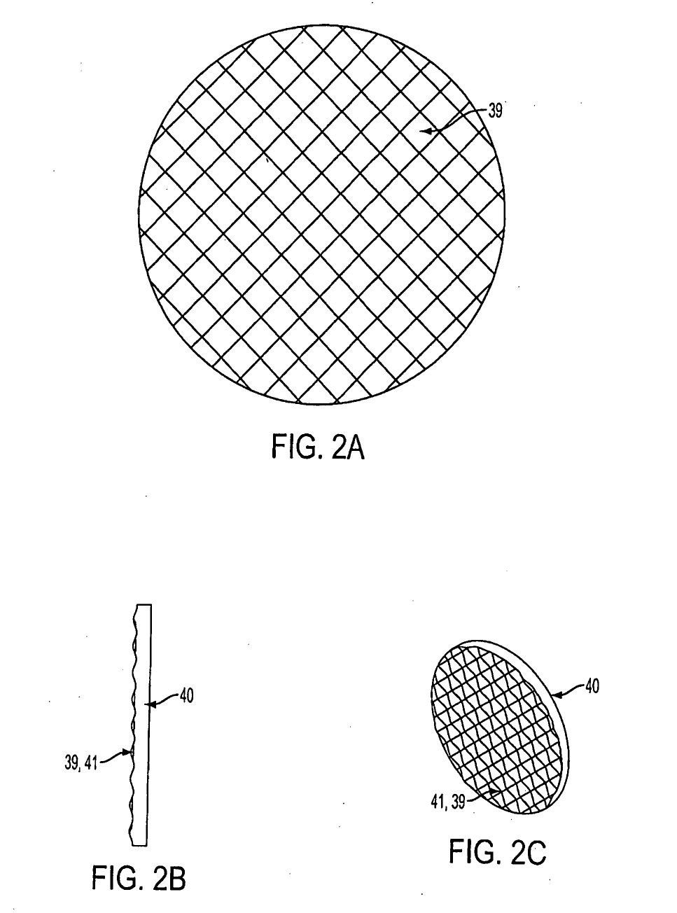

The diffusing lens, either the single lens 10 or a separate lens 37 may be comprised of a prismatic material or any other shape of lens which does not focus the light into a beam. Diverging lenses which are thicker at the edges than in the center can also be used. Diverging lenses can be bioconcave (having two concave faces), plano-concave (having a plane face and a concave face), or concavo-convex or a diverging meniscus (having a convex face and a concave face with a smaller radius of curvature). Fresnel lenses can also be made to be diverging lenses. Referring to FIGS. 2a-c, FIG. 2a is a front view of a prismatic lens 10 showing the prisms 39 on the surface. FIG. 2b is a side view of the same lens showing the smooth side 40 and the side with prisms 41.

Referring to FIG. 1, the thru-hull assembly is secured to the inside of the vessel hull using a locking ring 7 having internal threads 36 which are sized to screw down on the external threads 27 of the main body 1. Locking ring 7 pulls flange 2 into position against the outside of the vessel hull. Optionally, in order to adapt the entire lighting assembly to slight angular variations in hull shapes, a compression ring 6 in combination with locking ring 7 is provided along the exterior mid-portion of main body 1. Although the mushroom-head shaped portion of front flange 2 must stay flush against the side of the boat at the hull opening, the compression ring and locking ring may be adjusted such that the main body of the assembly may tilt slightly in order to accommodate angle variations in the hull. The compression ring is preferably composed of aluminum and has a smooth interior and exterior surface. The compression ring surrounds the exterior of the mid-portion of the main body and acts as a washer separating the main body from the walls of the hull. The corners of the compression ring are beveled so as to provide smooth contact with the walls of the hull. At the distal side of the compressions ring, locking ring 7 is screwed onto the mid-portion of the main body via its threaded interior surface. The locking ring is also preferably composed of aluminum. Along the circumference of the locking ring are six cap screws 21 whose bodies extend past the locking ring and abut the distal side of the compression ring. Thus, in order to vary the angle at which the compression ring aligns the assembly with the walls of the hull, each of screws 21 may be individually threaded in the bores of the locking ring at different heights so as to change the angle of the abutting compression ring.

Optionally, the underwater light can comprise a two-piece thru-hull in which the external flange and internal housing can be manufactured from the most preferred materials for the environment and/or application. The present invention requires the use of metals having sufficient structural strength and corrosion resistance to comprise the components of the assembly exposed to the water in order to maintain a water tight seal below the waterline. Materials used inside the hull must have sufficient mechanical strength for secure fastening to the flange and should have appropriate heat transfer properties to minimize heat buildup in the view port. Table 1 is a list of the galvanic potential of various common metals starting with magnesium which is the most reactive and ending with platinum which is the least reactive.

TABLE 1
Galvanic Properties

| Most Reactive | Least Reactive |
|---|---|
| MAGNESIUM | COPPER (CA102) |
| MAGNESIUM ALLOYS | MANGANESE BRONZE (CA |
| | 675), TIN BRONZE (CA903, |
| | 905) |
| ZINC | SILICON BRONZE |
| ALUMINUM 5052, 3004, 3003, 1100, | NICKEL SILVER |
| 6053 | |
| CADMIUM | COPPER-NICKEL ALLOY |
| | 90-10 |
| ALUMINUM 2117, 2017, 2024 | COPPER-NICKEL ALLOY |
| | 80-20 |
| MILD STEEL (1018), WROUGHT | 430 STAINLESS STEEL |
| IRON | |
| CAST IRON, LOW ALLOY HIGH | NICKEL, ALUMINUM, |
| STRENGTH STEEL | BRONZE (CA 630, 632) |
| CHROME IRON (ACTIVE) | MONEL 400, K500 |
| STAINLESS STEEL, 430 SERIES | SILVER SOLDER |
| (ACTIVE) | |
| 302, 303, 304, 321, 347, 410, 416, | NICKEL (PASSIVE) |
| STAINLESS STEEL (ACTIVE) | |
| NI-RESIST | 60 NI-15 CR (PASSIVE) |
| 316, 317, STAINLESS STEEL | INCONEL 600 (PASSIVE) |
| (ACTIVE) | |
| CARPENTER 20 CB-3 STAINLESS | 80 NI-20 CR (PASSIVE) |
| (ACTIVE) | |
| ALUMINUM BRONZE (CA 687) | CHROME IRON (PASSIVE) |
| HASTELLOY C (ACTIVE) INCONEL | 302, 303, 304, 321, 347, |
| 625 (ACTIVE) TITANIUM (ACTIVE) | STAINLESS STEEL |
| | (PASSIVE) |
| LEAD-TIN SOLDERS | 316, 317, STAINLESS STEEL |
| | (PASSIVE) |
| LEAD | CARPENTER 20 CB-3 |
| | STAINLESS (PASSIVE), |
| | INCOLOY 825 |
| TIN | NICKEL-MOLYBDEUM- |
| | CHROMIUM-IRON ALLOY |
| | (PASSIVE) |
| INCONEL 600 (ACTIVE) | SILVER |
| NICKEL (ACTIVE) | TITANIUM (PASS.) |
| | HASTELLOY C & C276 |
| | (PASSIVE), INCONEL |
| | 625(PASS.) |
| 60 NI-15 CR (ACTIVE) | GRAPHITE |
| 80 NI-20 CR (ACTIVE) | ZIRCONIUM |
| HASTELLOY B (ACTIVE) | GOLD |
| BRASSES | PLATINUM |

It is preferred to use materials from the least reactive materials in Table 1 that have the appropriate mechanical properties for the application. Standard marine fittings are generally made of bronze or 316 or 317 stainless steel for both their strength and corrosion resistance when used below the waterline. While these materials offer excellent corrosion resistance, they do not dissipate heat well. As such, they are less preferred for use in applications where heat may be generated such as in a light or camera housing. When the assembly will hold a heat emitting device, it is preferred that the body of the assembly be made from materials capable of rapidly dispersing the heat such as aluminum or copper. Most grades of aluminum however create a galvanic cell and corrode rapidly when immersed in an aqueous environment in the presence of any other metals. Furthermore, saltwater is an excellent electrolyte and fosters the creation of galvanic currents. As such, aluminum is a poor choice for any external use on any vessel hull and in no instance should aluminum be directly welded or affixed to steel hull vessels. In the marine environment, other metals are always present in the form of standard bronze through hull plumbing fittings, bronze and stainless propellers, rudder hardware, etc. While plastics do not corrode and have been used in through hull devices, they lack sufficient strength and durability for use in below the waterline applications. They are also cosmetically unappealing in comparison to highly polished metals.

The present invention allows for the use of corrosion resistant materials on the wet outside of the vessel hull and the use of heat dissipating materials on the dry inside of the vessel hull. For example, the flange can be made of a corrosion resistant metal such as bronze, stainless steel, or titanium. The body is preferably made of a strong heat dissipating metal such as aluminum, titanium or brass or alloys thereof.

In one embodiment of the view port, the flange 2 can be directly welded to the vessel hull. When welded, there is no need to bed the flange to the hull to reduce leaks and the internal locking and compression rings are eliminated.

As shown in FIG. 1, when used with a light or camera, a reflector housing 4 is slip fit or optionally threaded into the inside of the main body. While primary water resistance is provided by the flange 2 and the o-ring 15, secondary water resistance can be provided by use of a threaded cap which is screwed onto the distal end of the main body. This cap may be a single piece or preferably two pieces comprising a threaded connecting ring 8 and a lid 9. The cap may be made out of any suitable metal or polymer material although marine grades of aluminum are most preferred due to their corrosion resistance and strength when used inside the vessel and their ability to rapidly dissipate heat compared to other materials having suitable mechanical properties. Connecting ring o-rings or gaskets 12 and lid o-rings or gaskets 14 are used to maintain a water tight seal between the connecting ring and the main body and the lid and the connecting ring. When used it is most preferred that the lid 9 is secured to the distal end of the connector ring 8 via a plurality of screws 24 in combination with locknuts 25 placed around the lid's circumference. The external surface of the cap or connector ring may be shaped for use with tools or contain ridges or other means to improve a hand grip when screwing or unscrewing the connector ring or cap from the main body. The connector ring and cap can also assume any design which does not interfere with its mechanical function. Such designs include aesthetically pleasing designs and designs to improve the heat dissipation of the cap or connector ring. Heat dissipation may be improved by the inclusion of a plurality of cooling fins, ridges or other means to increase the surface area for heat dissipation or to facilitate additional air flow around or through portions of the cap, connector ring or lid.

When used with a wired device such as a lamp or camera, the lid contains a cable strain relief structure 19 for coupling to a cable that originates from inside the boat and provides power to and/or a signal from the device mounted inside the view port assembly. Signals transmitted include still or video images, infrared or other sensors capable of receiving data through a view port. Porcelain terminal blocks 18 serve to electrically and mechanically connect the lamp socket 16, camera or sensor structure to the lid via cap screws 22. The lamp socket may be elongated as necessary to place the lamp in the optimal location within the reflector housing for light and heat dissipation or alternatively the socket can be position using spacers between the socket and the lid. Also, non conducting standoff bodies may be placed between the terminal block and projector lid so as to change the placement of the terminal block with respect to the projector lid when needed. The lamp socket contains a lamp 17 which may be of one of several types including halide, halogen or xenon gas.

For lamp or camera replacement, the connector ring 8 is accessed from inside the hull and is unscrewed such that the connector ring and lid assembly, which is connected to the lamp or camera, may be removed in the distal direction. The remaining components of the lighting assembly remain in the thru-hull thereby leaving a sealed viewing hole in place during repair.

When used as a lamp, a reflector tube 4 is mounted inside and adjacent to the hollow interior of the main body and adjacent to the interior surface of the main body. The reflector tube 4 houses lamp 17 and supports a reflector 5 at its proximal end. The reflector tube is preferably composed of a heat dissipating material such as aluminum and is shaped such that the distal end of the reflector tube is affixed between the distal end of the main body and the connector ring and the proximal end is secured between the proximal end of the reflector tube and a glass retaining ring 3. While any suitable mechanical means is acceptable, the use of a lip on the proximal and distal end of the reflector housing is most preferred.

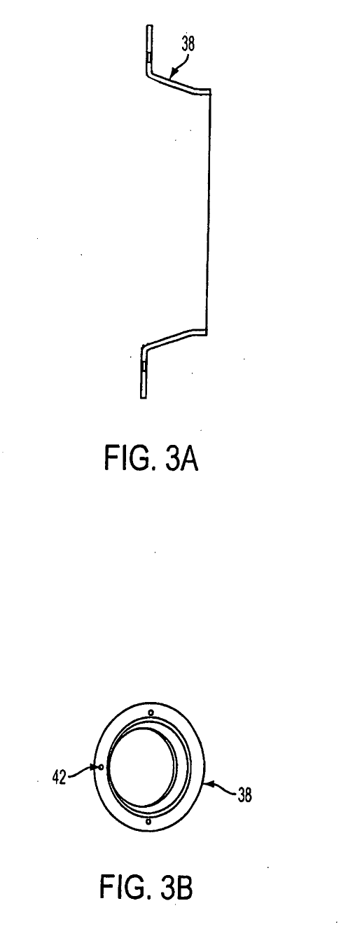

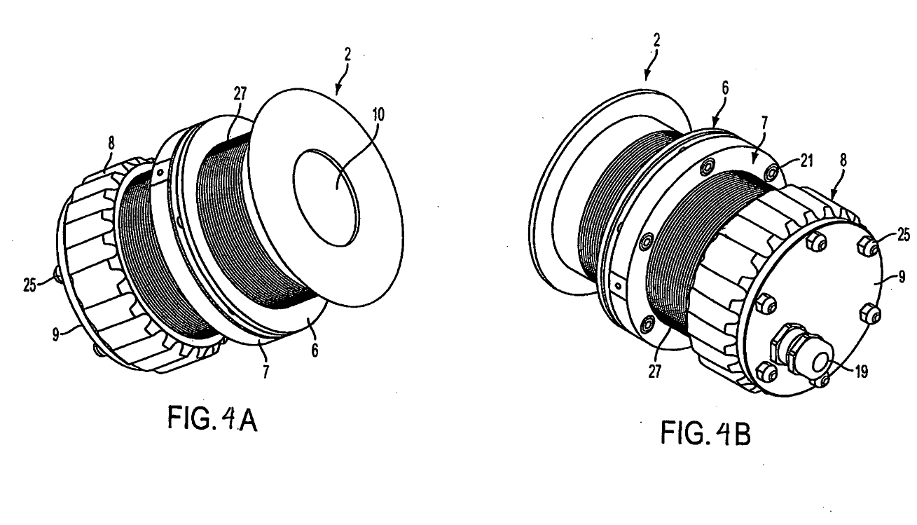

A watertight connection within the reflector housing is maintained by gasket 12 between the lip of the reflector tube and connecting ring. Any heat and water resistant gasket material such as Aramid/Buna-N sheet gasket material can be used for the gasket. A resilient polymer o-ring 13, preferably composed of nitrile rubber, lies between the distal ends of the reflector tube and main body so as to ensure a watertight seal between the reflector tube and adjacent components. Reflector 5 has a parabolic curved surface which protrudes rearward into the hollow interior of the assembly towards the distal end. Lamp 17 extends through the circular aperture at the center of the parabolic surface such that the reflector serves to provide maximum light projection and brightness from lamp 17.

Where a separate, diffusing lens 37 is used to diffuse the light from light source 17, a retaining ring 38 may be used to secure diffusing lens 37 to main body 1 of the housing as shown in FIG. 1. Referring to FIGS. 3a and 3b, in a preferred embodiment, a lip is used to secure the retaining ring in place within the main body 1. As show in FIG. 1, the lip is held in place between the lip of reflector 5 and the glass retaining ring 3 inside the main body 1. As shown in FIG. 3b, the retaining ring 38 contains screw holes 42 along the circumference of the lip through which bolts 20 are threaded in order to secure the retaining ring 38 to the glass retaining ring 3. In other embodiments, the retaining ring 38 is simply held in place by the structure of the reflector tube 4. Retaining ring 38 is preferably composed of aluminum.

As is apparent to one of skill in the art that various details of the present invention can be modified without deviating from the spirit of the invention. The use of alternative materials such as metals, sealants, polymers and transparent glasses and polymers is both contemplated and expected as improvements are made in the relevant art.

We claim:

1. An underwater light comprising:
a housing for attachment to a vessel hull having an internal and an external opening,
a lens sized to cover the external opening,
a light source,
a means for diffusing the light generated by the light source, and
a means for securing the lens in a watertight fashion to the external opening.

2. The underwater light of claim 1 wherein the means of diffusing the light passing through the external opening is the lens whereby the lens has an uneven surface on at least one side of the lens.

3. The underwater light of claim 1 wherein the means of diffusing the light passing through the external opening is a separate transparent diffusing lens which has an uneven surface on at least one side of the lens.

4. The underwater light of claim 3 wherein the means of diffusing the light passing through the external opening is a separate, discrete component placed on either side of the lens.

5. The underwater light of claim 3 wherein the diffusing lens is selected from a divergent lens, a prismatic lens, or a fresnel lens.

6. The underwater light of claim 3 wherein the diffusing lens is mounted in a lens retainer.

7. The underwater light of claim 3 wherein the diffusing lens is bonded in the housing.

8. The underwater light of claim 1 further comprising a cap threaded onto the distal end of the housing.

9. An underwater light comprising:
a housing for attachment to a vessel hull having an internal and an external opening,
a lens sized to cover the external opening wherein the lens diffuses the light passing through it,
a means for securing the lens in a watertight fashion to the external opening, and
a light source.

10. The underwater light of claim 9 wherein the means for diffusing the light passing through the external opening is a single lens having an uneven surface on at least one side of the lens.

11. The underwater light of claim 9 wherein the diffusing lens is selected from the group consisting of a divergent lens, a prismatic lens or a fresnel lens.

12. An underwater light comprising:
an external flange having an external opening,
a cylindrical, hollow main body removably attached to the external flange,
a lens sized to fit the external opening of the external flange,
a means for securing the lens to the external flange,
a light source,
a means for providing a watertight seal on both sides of said lens,
a means for diffusing the light generated by the light source, and
a means for securing the housing to a vessel.

13. The underwater light of claim 12 wherein the means of diffusing the light passing through the external opening is the lens whereby the lens has an uneven surface on at least one side of the lens.

14. The underwater light of claim 12 wherein the means of diffusing the light passing through the external opening is a separate transparent diffusing lens which has an uneven surface on at least one side of the lens.

15. The underwater light of claim 12 wherein the means for diffusing the light is a selected from the group comprising a divergent lens, a prismatic lens or a fresnel lens.

16. The underwater light of claim 27 wherein the diffusing lens is mounted in a lens retainer.

17. The underwater light of claim 27 wherein the diffusing lens is bonded in the housing.

18. The underwater light of claim 25 wherein the means for securing the housing is selected from bonding, welding or mechanical fastening.

19. The underwater light of claim 25 wherein the means for securing the lens to the external flange is selected from bonding, welding or mechanical fastening.

20. The underwater light of claim 39 wherein the mechanical means for securing the lens to the external flange is a lens retaining ring.
